(19) United States
(12) Patent Application Publication
(10) Pub. No.: US 2013/0000270 A1
(43) Pub. Date: Jan. 3, 2013

(54) SYSTEM AND METHOD FOR COOLING GASIFICATION REACTOR

(76) Inventors: Lishun Hu, Shanghai (CN); Wei Chen, Shanghai (CN); Zhaohui Yang, Shanghai (CN); Minggang She, Shanghai (CN); Xianglong Zhao, Shanghai (CN); Richard Anthony DePuy, Burnt Hills, NY (US); Judeth Brannon Corry, Manvel, TX (US)

(21) Appl. No.: 13/537,156

(22) Filed: Jun. 29, 2012

(30) Foreign Application Priority Data
Jun. 30, 2011 (CN) 201110181439.5

(51) Int. Cl. F02C 3/28; C10J 3/72

(52) U.S. Cl. 60/39.12; 48/87; 165/53

(57) ABSTRACT

An exemplary gasification reactor is disclosed including a vessel defined with a reaction chamber for receiving a carbon-containing fuel and an oxygen-containing gas under a partial combustion and producing a synthesis gas. A first cooling device and a second cooling device are provided to cool the vessel. The first cooling device is attached to a first upper region of the vessel. The second cooling device is attached to the second middle region of the vessel. A method and IGCC power generation system is also disclosed.

### BACKGROUND

Embodiments of the invention relate generally to integrated gasification combined-cycle (IGCC) power generation systems, and more particularly to a system and a method for cooling a gasification reactor or gasifier of the IGCC systems.

At least some known IGCC systems includes a gasification system that is integrated with at least one power-producing turbine system. The gasification system may include a gasifier for converting a mixture of fuel, air or oxygen, steam, and/or solid, such as limestone or other fluxant, into an output of partially combusted gas, sometimes referred to as “syngas” and slag. A combustion process occurring in the gasifier may generate a great amount of heat. The temperatures during the combustion process may exceed 1600-1800 degrees Celsius. An internal liner may be used to protect the wall of the gasifier from elevated temperatures so as to prolong the lifetime of the gasifier.

A variety of different types of liners are known. For example, one type of liner includes refractory bricks that insulate the wall of the gasifier from the high temperatures. However, one drawback of using refractory bricks is that the bricks require replacement, which increases the operating expense of the gasifier. Additionally, gasifier walls that utilize refractory bricks may require warm-up or cool-down periods to avoid thermal shock damage.

Therefore, it is desirable to provide systems and methods to address at least one of the above-mentioned challenges.

### BRIEF DESCRIPTION

In accordance with one embodiment disclosed herein, a gasification reactor including a vessel, a first cooling device, and a second cooling device is provided. The vessel defines a reaction chamber for receiving a carbon-containing fuel and an oxygen-containing gas under a partial combustion and producing a synthesis gas. The vessel includes a first upper region and a second middle region. The first cooling device is attached to the first upper region. The second cooling device is attached to the second middle region.

In accordance with another embodiment disclosed herein, a cooling system capable of being used to cool a gasification reactor is provided. The cooling system includes a first cooling device and a second cooling device. The first cooling device is attached to a first upper region of the gasification reactor. The second cooling device is attached to a second middle region of the gasification reactor. The first cooling device and the second cooling device are configured to have shapes matching with the first upper portion and the second middle region respectively.

In accordance with another embodiment disclosed herein, a gasification reactor including a vessel and a heat exchanger is provided. The vessel defines a reaction chamber for carbon-containing fuel and oxygen-containing gas to partially combust therein. The vessel has an outer side and an inner side. The heat exchanger is attached to at least a portion of the outer side of the vessel. The heat exchanger is configured for absorbing heat from the reaction chamber.

In accordance with another embodiment disclosed herein, a method of regulating a temperature of a vessel of a gasification reactor. The method includes obtaining a temperature profile of the gasification reactor, the temperature profile including at least a first temperature zone around the first region of the gasification reactor and a second temperature zone around the vessel body of the gasification reactor; employing a first cooling strategy to cool the first region of the gasification reactor according to the obtained first temperature zone around the first region of the gasification reactor by using a first cooling device associated with the first region; and employing a second cooling strategy to cool the second region of the gasification according to the obtained second temperature zone around the second region of the gasification reactor by using a second cooling device associated with the second region.

In accordance with another embodiment disclosed herein, an integrated gasification combined-cycle (IGCC) power generation system is provided. The IGCC power generation system includes a gasifier and a gas turbine. The gasifier includes a vessel and a cooling system. The vessel defines a reaction chamber therein to receive a carbon-containing fuel and an oxygen-containing gas therein under a partial combustion and produce a synthesis gas therein. The vessel includes a first region and a second region. The cooling system includes a first cooling device associated with the first region and a second cooling device associated with the second region. The gas turbine is coupled in flow communication to the gasifier. The gas turbine is configured to combust the synthesis gas received from the gasifier.

### DRAWINGS

These and other features, aspects, and advantages of the present disclosure will become better understood when the following detailed description is read with reference to the accompanying drawings in which like characters represent like parts throughout the drawings, wherein:

FIG. 1 is a partially cutaway perspective view of a gasification reactor in accordance with an exemplary embodiment of the present disclosure.

FIG. 2 is a partially cutaway perspective view of a gasification reactor in accordance with another exemplary embodiment of the present disclosure.

FIG. 3 is a partially cutaway perspective view of a gasification reactor in accordance with yet another exemplary embodiment of the present disclosure.

FIG. 4 is a partially cutaway perspective view of a gasification reactor in accordance with an exemplary embodiment of the present disclosure.

FIG. 5 is a partially cutaway perspective view of a gasification reactor in accordance with an exemplary embodiment of the present disclosure.

FIG. 6 is a perspective view of a gasification reactor associated with a heat exchanger in accordance with an exemplary embodiment of the present disclosure.

FIG. 7 is a perspective view of a gasification reactor associated with a heat exchanger in accordance with another exemplary embodiment of the present disclosure.

FIG. 8 is a perspective view of a gasification reactor associated with a heat exchanger in accordance with yet another exemplary embodiment of the present disclosure.

FIG. 9 is a perspective view of a gasification reactor associated with a heat exchanger in accordance with yet another exemplary embodiment of the present disclosure.

FIG. 10 is a schematic diagram of an integrated gasification combined-cycle (IGCC) power generation system in accordance with an exemplary embodiment of the present disclosure.

### DETAILED DESCRIPTION

Embodiments disclosed herein relate to cooling devices used in association with a gasification reactor or gasifier to cool a vessel of the gasifier. Further, some embodiments relate to methods of using the cooling devices to cool the gasification reactor. In some embodiments, active cooling devices may be used to cool the gasification reactor. Still in some embodiments, heat exchanger is mounted to the outer side of the vessel of the gasifier to either cool or deliver heat to the vessel of the gasification reactor.

Unless defined otherwise, technical and scientific terms used herein have the same meaning as is commonly understood by one of ordinary skill in the art to which this disclosure belongs. The terms “First”, “second”, and the like, as used herein do not denote any order, quantity, or importance, but rather are used to distinguish one element from another. Also, the terms “a” and “an” do not denote a limitation of quantity, but rather denote the presence of at least one of the referenced items. The use of “including,” “comprising” or “having” and variations thereof herein are meant to encompass the items listed thereafter and equivalents thereof as well as additional items. The terms “connected” and “coupled” are not restricted to physical or mechanical connections or couplings, and can include electrical connections or couplings, whether direct or indirect.

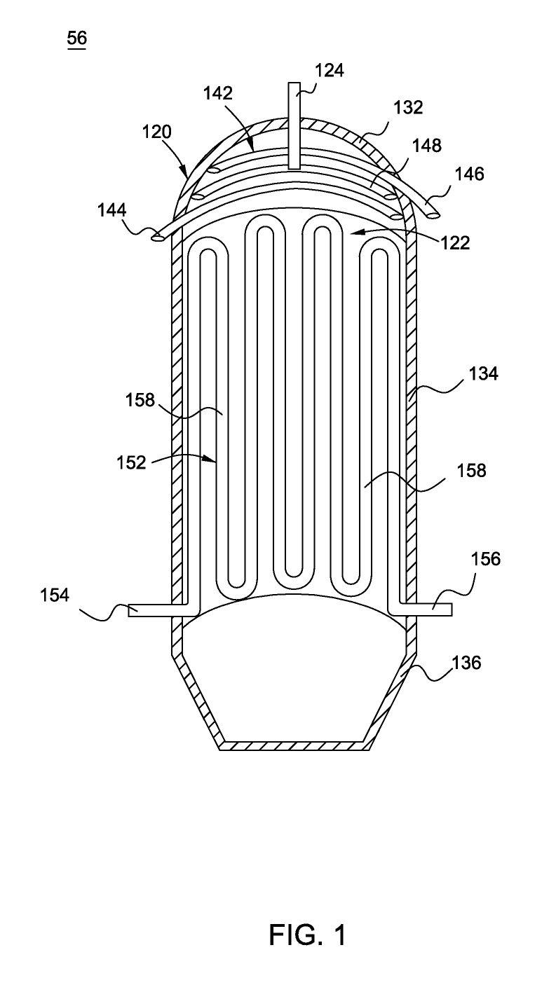

FIG. 1 is a partially cutaway perspective view of a gasifier 56 in accordance with an exemplary embodiment of the present disclosure. For purpose of illustration, in the embodiment of FIG. 1, the gasifier 56 is shown as an entrained flow gasifier. However, it can be contemplated that the gasifier 56 may be applied to any other types of gasifier, including but not limited to a fixed bed gasifier, or a fluidized bed gasifier, as long as these gasifiers can embody one or more aspects of cooling devices and methods which will be discussed with greater details below.

Referring to FIG. 1, the entrained flow gasifier 56 includes a shell or vessel 120 which defines a reaction chamber 122 therein. The reaction chamber 122 is defined for receiving a carbon-containing fuel and an oxygen-containing gas therein. The carbon-containing fuel and the oxygen-containing gas may be introduced into the reaction chamber 122 via an injector (also referred to as burner) 124 disposed on the top of the vessel 120. It can be contemplated that the injector 124 may be disposed at various angles and various locations of the vessel 120. In a combustion process, the carbon-containing fuel and the oxygen-containing gas introduced into the reaction chamber 122 via the injector 124 may be burned at elevated pressures, e.g., from approximately 20 bar to approximately 85 bar, and temperatures, e.g., approximately 700 degrees Celsius to approximately 1800 degrees Celsius, depending on the type of gasifier 56 utilized, and a synthesis gas is produced.

Further referring to FIG. 1, the vessel 120 includes a first upper region 132, a second middle region 134, and a third lower region 136. In the embodiment of FIG. 1, the first upper region 132 is formed to have a dome shape, the second middle region 134 is formed to have a cylindrical shape, and the third lower region 136 is formed to have a cone shape. In the embodiment of FIG. 1, for purpose of illustration only, the first upper region 132, the second middle region 134, and the third lower region 136 are shown as being integrally formed. In other embodiments, it can be contemplated that the three regions 132, 134, 136 may be separately formed, and then joined together by any appropriate means, such as welding or adhesion.

In one embodiment of FIG. 1, in order to provide cooling of the wall of the vessel 120 so as to protect the vessel 120 from high temperature during the combustion process, a first cooling device 142 and a second cooling device 144 are provided. The first cooling device 142 is associated with the first upper region 132 used for cooling and protecting the wall of the first upper region 132. The second cooling device 144 is associated with the second middle region 134 for cooling and protecting the wall of the second middle region 134.

More specifically, the first cooling device 142 is constructed to have a shape matched with the first upper region 132. For example, the first cooling device 142 is a conical pipe which is substantially matched with the dome-shaped first upper region 132. It can be contemplated that, in other embodiments, the first cooling device 142 may use pipes configured with other shapes matched with the first upper region 132. In the embodiment of FIG. 1, the first cooling device 142 is attached to the inner side of the first upper region 132 by any appropriate means, such as welding or adhesion. In other embodiments, the first cooling device 142 may be attached to the outer side of the first upper region 132. Yet in some embodiments, the first cooling device 142 may be embedded inside the wall of the first upper region 132 of the vessel 120. Still in some embodiments, although not illustrated in the FIG. 1, a refractory liner may be further provided with a configuration that the first cooling device 142 may be sandwiched between the refractory liner and the inner side of the first upper region 132.

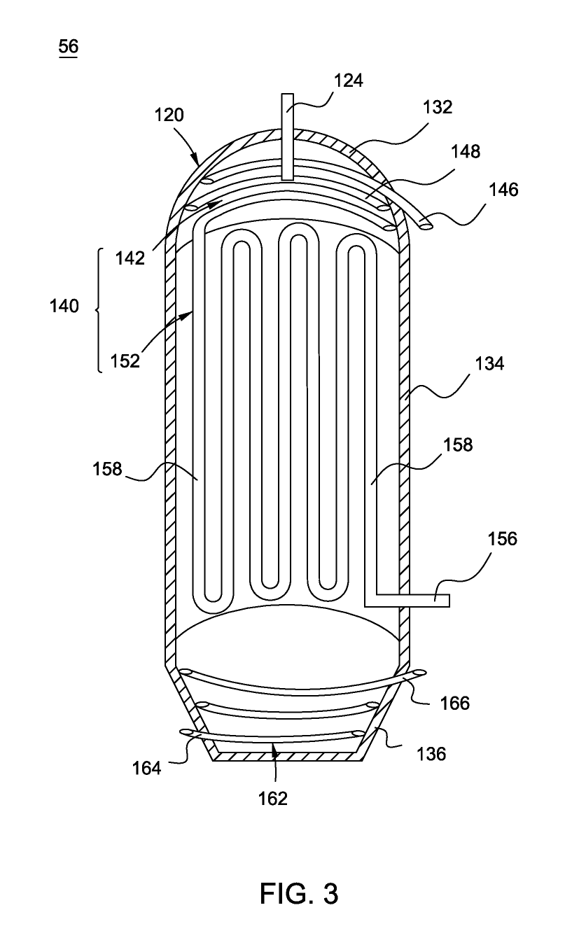

In one embodiment, as shown in FIG. 1, the first cooling device 142 may be operated independently with respect to the second cooling device 152 for providing localized cooling of the first upper region 132. In other embodiments, for example, as will be described below with reference to FIG. 3, the first cooling device 142 may be combined with the second cooling device 152 to form a single cooling system 140 for providing cooling to both the first upper region 132 and the second middle region 134. In the embodiment of FIG. 1, the first cooling device 132 is an active cooling device, which includes an inlet 144, an outlet 146, and intermediate pipes 148 having increasing diameters connected between the inlet 144 and the outlet 146.

In operation of the first codling device 132, coolant such as water or steam may be introduced through the inlet 144 and circulated through the intermediate pipes 148. The coolant carried with heat then is withdrawn or discharged from the outlet 146 and may be subsequently cooled and recirculated through the intermediate pipes 148. It can be understood that by operating the active first cooling device 132, heat, particularly the heat generated adjacent the wall of first upper region 132 of the vessel 120 is transferred with the coolant circulating through the pipes 148. Thus, the temperature of the wall of the first upper region 132 can be maintained at a desired temperature. It should be noted that the desired temperature of the first upper region 132 can be adjusted by varying various parameters in association with the heat transfer process. For example, the velocity or flow rate of the coolant circulating through the pipes 148 may be increased to transfer more heat in a given time period and to provide more cooling to the first upper region 132, when the temperature of the wall of the first upper region 132 is determined to be higher than a threshold value. The temperature of the first upper region 132 may be detected in real-time by using thermal sensors attached to the first upper region 132 for example, and the detected temperature is then used for determining whether the first upper region 132 needs to be heated or cooled. As used herein, a term of “cooling strategy” can be defined to briefly refer to means of varying various parameters in association with a heat transfer process to adjust the desired temperature of the wall of a vessel.

With continuing reference to FIG. 1, in the embodiment of FIG. 1, the second cooling device 152 is also constructed to have an overall shape matching with the second middle region 134 which is cylindrical in shape. The second cooling device 152 is also an active cooling device which generally includes an inlet 154, an outlet 156, and a plurality of vertical pipes 158 connected between the inlet 154 and the outlet 156. In the embodiment of FIG. 1, the plurality of pipes 158 extend in parallel along a longitudinal axis (or top-down direction) of the second middle region 134, and are connected end to end. The plurality of pipes 158 are secured to the inner side of the cylindrical second middle region 134. Similarly, coolant may be introduced via the inlet 154 to circulate through the pipes 158 and discharged from the outlet 156, such that the wall of the second middle region 134 can be maintained at a desired temperature.

With continuing reference to FIG. 1, in the embodiment of FIG. 1, a cooling strategy may be implemented at the second middle region 134 by varying various parameters in association with heat transfer process at the second middle region 134. Further, the cooling strategies implemented at the first cooling device 142 and the second cooling device 152 may be coordinated in regulating the temperature of the first upper region 132 and the second middle region 134. In the combustion process, for given gasification conditions, the vessel 120 of the gasifier 56 generally has a temperature profile along a top-down direction. For example, the first upper region 132 of the vessel 120 may have a lower temperature than the second middle region 134. In this case, in some embodiments, the coolant flowing through the pipes 148 of first cooling device 132 may be adjusted to have its velocity or flow rate smaller than that of the coolant flowing through the pipes 158 of the second cooling device 152. As a result, the wall of the first upper region 132 and the wall of the second middle region 134 can be maintained substantially at a same temperature, which may reduce thermal stress between the wall of the two regions 132 and 134, and further prolong the lifetime of the vessel 120 of the gasifier 56.

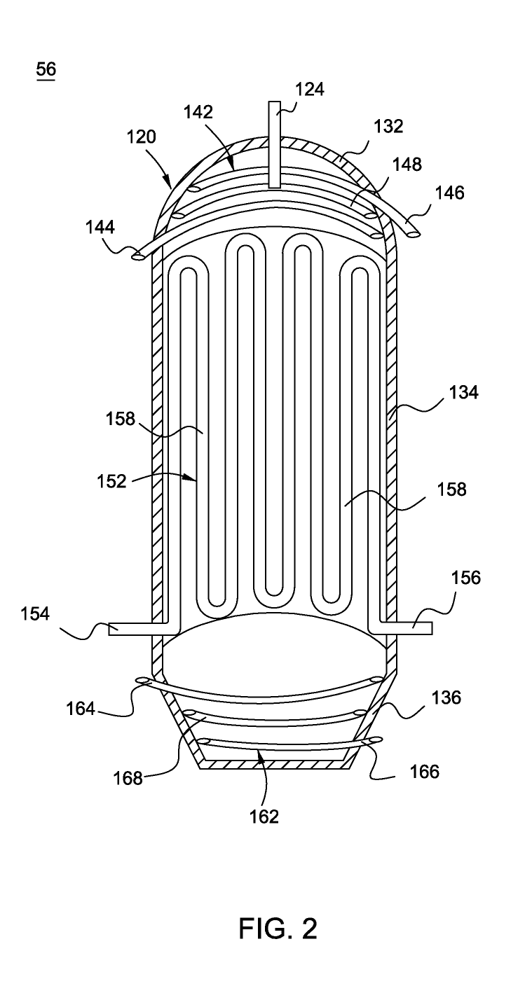

FIG. 2 is a partially cutaway perspective view of a gasifier 56 in accordance with another exemplary embodiment of the present disclosure. The embodiment of FIG. 2 is similar to the embodiment described above in reference to FIG. 1. The difference is that for providing further cooling to the vessel 120, a third cooling device 162 is associated with the third lower region 136 of the vessel 120.

More specifically, in the embodiment of FIG. 2, the third cooling device 162 is attached to the inner side of the third lower region 136, and is constructed to have conical shaped pipes matching with the cone-shaped third lower region 136. The third cooling device 162 is also an active cooling device which includes an inlet 164, an outlet 166, and conical pipes 168 interconnected between the inlet 164 and outlet 166. It should be understood that the conical pipes 168 is for illustration purpose only, in other embodiments, other shapes of pipes can be used to match with the third lower region 136. In operation of the third cooling device 162, coolant may be introduced via the inlet 164 to circulate through the pipes 168 and discharged from the outlet 166, such that the wall of the third lower region 136 can be maintained at a desired temperature.

With continuing reference to FIG. 2, in the embodiment of FIG. 2, a cooling strategy may be implemented at the third lower region 136 by varying various parameters in association with heat transfer process by operating the third cooling device 162. Further, the cooling strategies implemented using the third cooling device 162 may be coordinated with the second cooling device 152 to maintain the wall of the second middle region 134 and the wall of the third lower region 136 at same temperature, which may reduce thermal stress between the walls of the two regions 134 and 136, and further prolong the lifetime of the vessel 120 of the gasifier 56.

FIG. 3 is a partially cutaway perspective view of a gasifier 56 in accordance with another exemplary embodiment of the present disclosure. In the embodiment of FIG. 3, instead of using independent cooling devices 142 and 152 as those shown in FIG. 1 and FIG. 2, a single cooling system 140 is provided for cooling the first upper region 132 and the second middle region 134. In the embodiment of FIG. 3, the cooling system 140 is formed by connecting the first cooling device 142 and the second cooling device 152 together. Similar to what has described with reference to FIG. 1 and FIG. 2, the first cooling device 142 has conical pipes matching with the first upper region 132, and the second cooling device 152 has vertical pipes matching with the second middle region 134. The cooling system 140 includes an inlet 146, an outlet 156, conical pipes 148, and vertical pipes 158.

In operation of the cooling system 140 shown in FIG. 3, coolant is introduced via the inlet 146 to sequentially circulate through the conical pipes 148 and vertical pipes 158 and discharged from the outlet 156, such that the wall of the first upper region 132 and second middle region 134 can be maintained at a desired temperature.

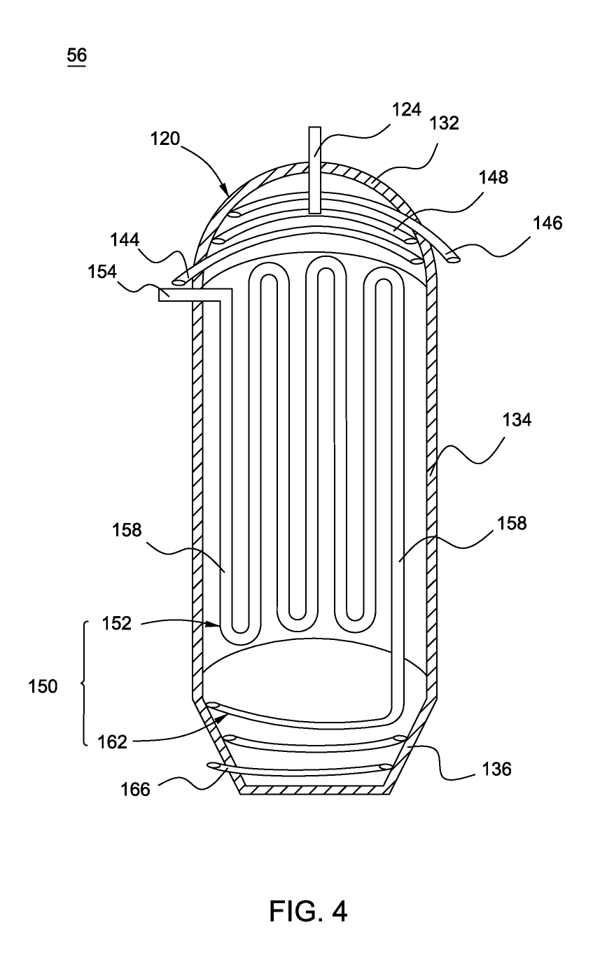

FIG. 4 is a partially cutaway perspective view of a gasifier 56 in accordance with yet another exemplary embodiment of the present disclosure. In the embodiment of FIG. 4, instead of using independent cooling devices 152 and 162 as those shown in FIG. 2, another single cooling system 150 is provided for cooling the second middle region 134 and the third lower region 136. In the embodiment of FIG. 4, the cooling system 150 is formed by connecting the second cooling device 152 and the third cooling device 162 together. Similar to what has described with reference to FIG. 1 and FIG. 2, the second cooling device 152 has vertical pipes matching with the second middle region 132, and the third cooling device 162 has conical pipes matching with the third lower region 136. The cooling system 150 includes an inlet 154, an outlet 166, vertical pipes 158, and conical pipes 164.

In operation of the cooling system 140 shown in FIG. 4, coolant is introduced via the inlet 154 to sequentially circulate through the vertical pipes 158 and conical pipes 174 and discharged from the outlet 166, such that the wall of the second middle region 134 and the third lower region 136 and can be maintained at a desired temperature.

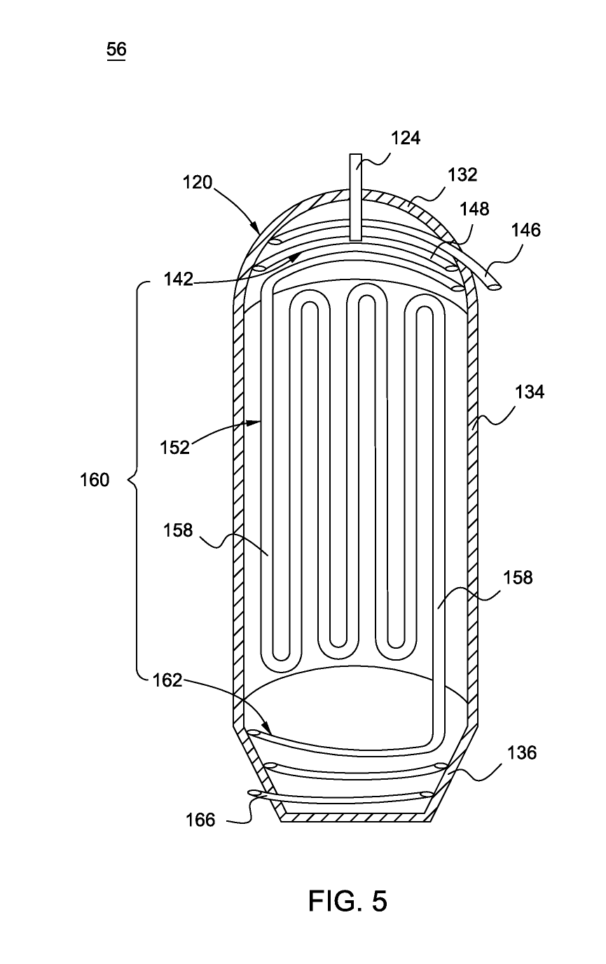

FIG. 5 is a partially cutaway perspective view of a gasifier 56 in accordance with yet another exemplary embodiment of the present disclosure. In the embodiment of FIG. 5, the first cooling device 142, the second cooling device 152, and the third cooling device 162 are connected together to form another cooling system 160. By introducing coolant via the inlet 146 and circulating through the conical pipes 148, vertical pipes 158, and the conical pipes 164, and discharged via the outlet 166, the wall of the first upper region 132, the second middle region 134, and the third lower region 136 can be maintained at a desired temperature.

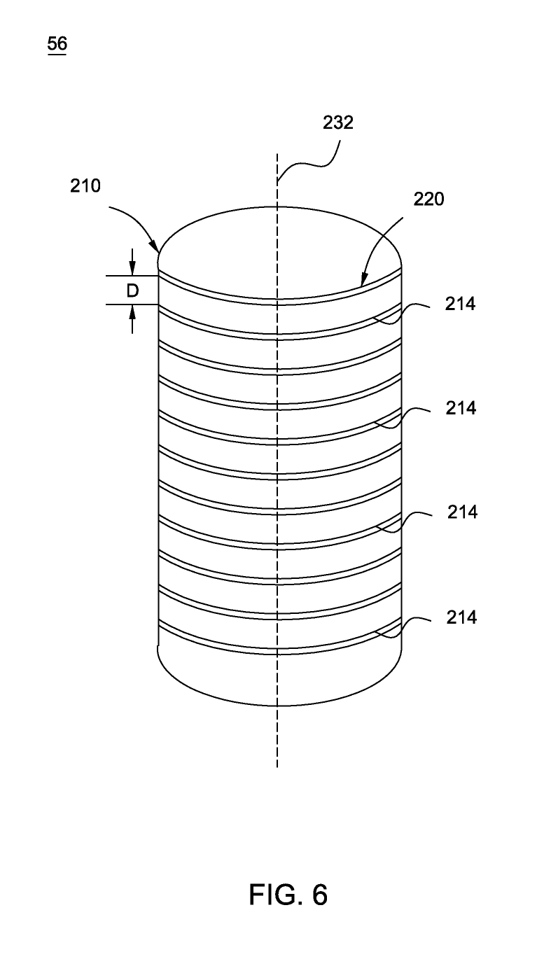

FIG. 6 is a schematic perspective view of a gasifier 56 in accordance with an exemplary embodiment of the present disclosure. The gasifier 56 includes a heat exchanger 220 which is attached to the outer side of the vessel 210. In general; the heat exchanger 220 can be configured to operate at a cooling mode and a heating mode.

In the cooling mode, the heat exchanger 220 may be operated to cool the wall of the vessel 210 by carrying out heat resulted from an internal combustion in the reaction chamber defined by the vessel 210. A lining of refractory (not shown) may be provided at the inner side of the vessel 210 of gasifier 56, so by providing cooling to the vessel 210 using the heat exchanger 220, the requirements for refractory inside the vessel can be reduced. Further, using the heat exchanger 220 to cool the vessel 210 could also cause slag to build up inside the vessel 210 and act as a sacrificial, and self-repairing refractory layer. In some embodiments which will be discussed below, the heat exchanger 220 may be designed with zones where the cooling could be different depending on the location of the zone on the vessel 210.

In the heating mode, the heat exchanger 220 may be operated to deliver heat to the wall of vessel 210 of the gasifier 56. It is useful to operate the heat exchanger 220 in the heating mode. For example, in a startup process, the heat exchanger 220 may be operated to heat the vessel 210 for warm up the wall of the vessel 210 so as to avoid thermal shock damage. In some embodiments which will be discussed below, the heat exchanger 220 may be designed with zones where the heating could be different depending on the location of the zone on the vessel 210.

In the embodiment of FIG. 6, the heat exchanger 220 is an active cooling device which includes a plurality of circular tubes 214 arranged perpendicular to a longitudinal axis (indicated by dashed line 232) of the vessel 210. In the embodiment of FIG. 6, the plurality of tubes 214 are evenly distributed along the longitudinal axis 232, for example, adjacent two tubes are spaced apart by a distance D. In other embodiment, it is possible that the plurality of tubes 214 may be unevenly distributed along the longitudinal axis 232. In one embodiment, each of the plurality of tubes 214 may be provided with an inlet and an outlet for introducing coolant and discharging coolant respectively, so the cooling device 220 is formed with multiple inlets and multiple outlets for supplying coolant and discharging coolant independently. In other embodiments, the plurality of tubes 214 may be connected together to have a single inlet and a single outlet for introducing coolant and discharging coolant respectively. It should be noted that the dimensions of the tubes 214 are illustrated for exemplary purposes, in practical implementations, the dimensions of the tubes 214 can be varied according to practical applications.

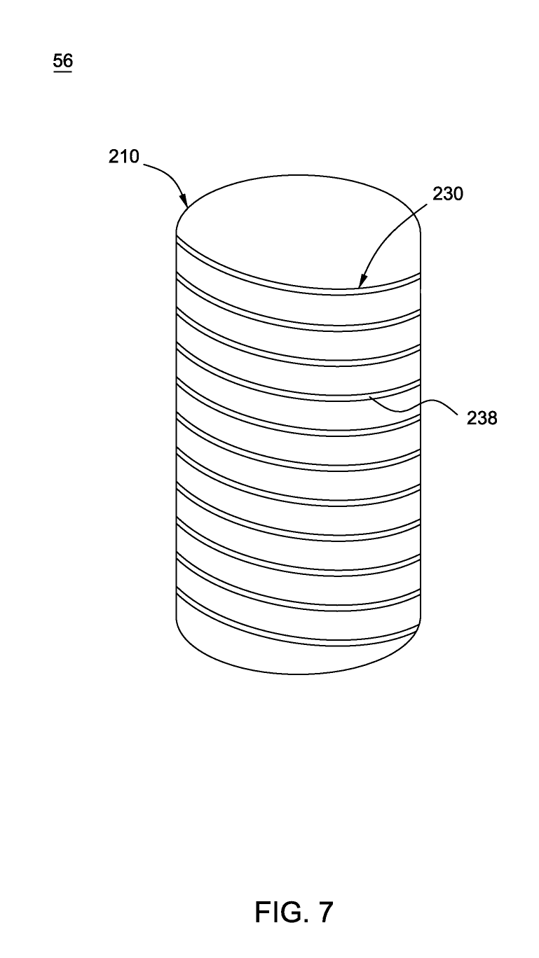

FIG. 7 is a schematic perspective view of a gasifier 56 in accordance with another exemplary embodiment of the present disclosure. In the embodiment of FIG. 7, the gasifier 56 is provided with a heat exchanger 230 which is also attached at the outer side of the vessel 210. The function of the heat exchanger 230 is similar to the heat exchanger 220 as described above in reference to FIG. 6. The difference is that the heat exchanger 230 has a spiral shaped pipe 238 for introducing coolant and discharging coolant.

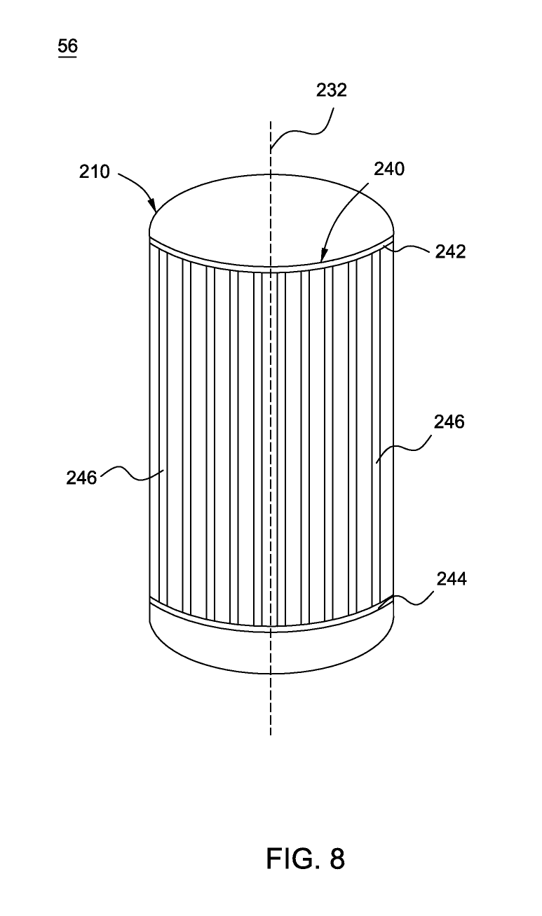

FIG. 8 is a schematic perspective view of a gasifier 56 in accordance with another exemplary embodiment of the present disclosure. In the embodiment of FIG. 8, the gasifier 56 is provided with a heat exchanger 240 which is also attached to the outer side of the vessel 210. The function of the heat exchanger 240 is similar to the heat exchanger 220 as described above in reference to FIG. 6. In the embodiment of FIG. 8, the heat exchanger 240 includes a first circular pipe 242, a second circular pipe 244, and a plurality of vertical pipes 246. The first circular pipe 242 and the second circular pipe 244 are arranged to be perpendicular to the longitudinal axis 232 of the vessel 210. Each of the plurality of vertical pipes 246 has one end connected to the first circular pipe 242 and the other end connected to the second circular pipe 244. The plurality of vertical pipes 246 are spaced apart from one another of the vessel 210. In the illustrated embodiment of the FIG. 8, the plurality of vertical pipes 246 are evenly distributed, it should be not so limited, unevenly distributed vertical pipes 246 could also be contemplated by skilled person in the art.

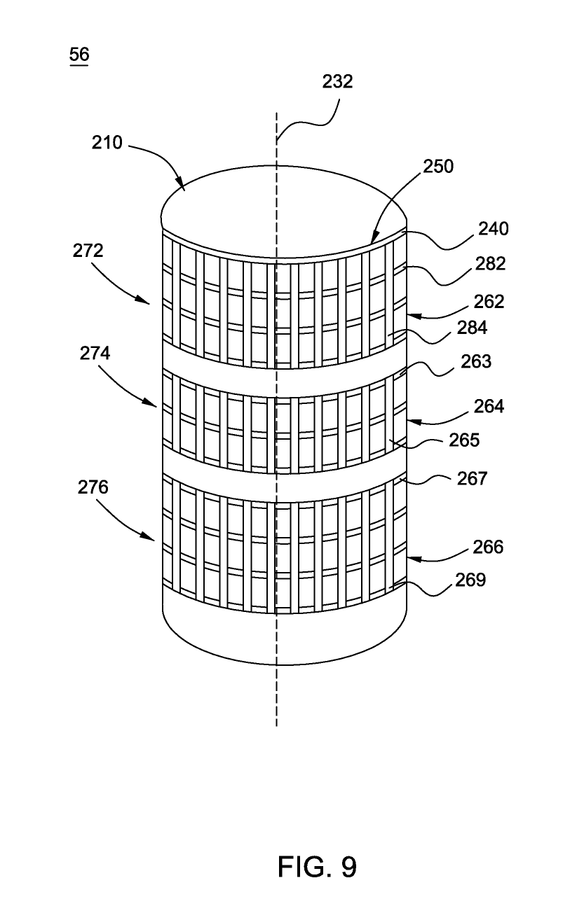

FIG. 9 is a schematic perspective view of a gasifier 56 in accordance with yet another exemplary embodiment of the present disclosure. In the embodiment of FIG. 9, the gasifier 56 is provided with a heat exchanger 250 which is also attached to the outer side of the vessel 210. The function of the heat exchanger 250 is similar to the heat exchanger 220 as described above in reference to FIG. 6. In the embodiment of FIG. 9, the heat exchanger 250 is shown to have three pipe assemblies 262, 264, 266 arranged at different zones of the vessel 210. The three pipe assemblies 262, 264, 266 may be operated independently to provide different cooling to different zones of the vessel 210. In some embodiments, the three pipe assemblies 262, 264, 266 may be coordinated to maintain different zones of the vessel 210 at same temperature. It should be understood that, the number of the pipe assembly may be set to be smaller than three or more than three according to practical applications.

More specifically, in the embodiment of FIG. 9, the first pipe assembly 262 is arranged at a first zone 272 in proximate to an upper region of the vessel 210, the second pipe assembly 264 is arranged at a second zone 274 in proximate to a middle region 274 of the vessel 210, and the third pipe assembly 264 is arranged at a third zone 276 in proximate to a lower region of the vessel 210. The first pipe assembly 262 includes a plurality of circular pipes 282 and a plurality of vertical pipes 284 that are intersected to form a matrix or web shaped pipe arrangements. The circular pipes 282 are arranged to be perpendicular to the longitudinal axis 232 of the vessel 210. Similarly, the second pipe assembly 264 includes a plurality of circular pipes 263 and a plurality of vertical pipes 265 that are intersected to form a matrix or web shaped pipe arrangements. The circular pipes 263 are arranged to be perpendicular to the longitudinal axis 232 of the vessel 210. The third pipe assembly 266 includes a plurality of circular pipes 267 and a plurality of vertical pipes 269 that are intersected to form a matrix or web shaped pipe arrangements. The circular pipes 267 are arranged to be perpendicular to the longitudinal axis 232 of the vessel 210.

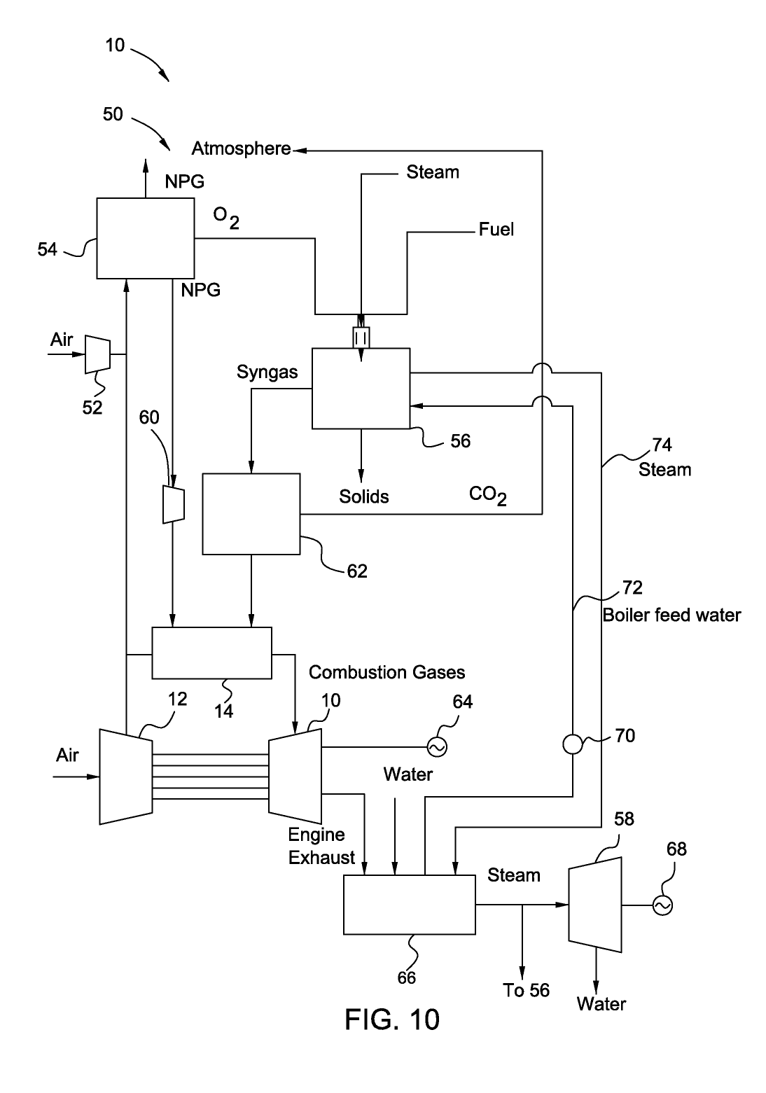

The various exemplary gasifier embodiments described above can be integrated in an integrated gasification combined-cycle (IGCC) power generation system. FIG. 10 is a schematic diagram of an exemplary IGCC system 50. IGCC system 50 generally includes an air compressor 52, an air separation unit 54 coupled in flow communication to the air compressor 52, a gasifier 56 coupled in flow communication to the air separation unit 54, a gas turbine 10 coupled in flow communication to the gasifier 56, and a steam turbine 58.

In operation, the air compressor 52 compresses ambient air that is channeled to air separation unit 54. In some embodiments, in addition to air compressor 52 or alternatively, compressed air from gas turbine compressor 12 is supplied to air separation unit 54. Air separation unit 54 uses the compressed air to generate oxygen for use by gasifier 56. More specifically, air separation unit 54 separates the compressed air into separate flows of oxygen (O₂) and a gas by-product, sometimes referred to as a “process gas”. The process gas generated by air separation unit 54 includes nitrogen and will be referred to herein as “nitrogen process gas” (NPG). The NPG may also include other gases such as, but not limited to, oxygen and/or argon. For example, in some embodiments, the NPG includes between about 95% and about 100% nitrogen. The O₂ flow is channeled to gasifier 56 for use in generating partially combusted gases, referred to herein as “syngas” for use by gas turbine 10 as fuel, as described below in more detail. In some IGCC systems 50, at least some of the NPG flow is vented to the atmosphere from the air separation unit 54. Moreover, in some of known IGCC systems 50, some of the NPG flow is injected into a combustion zone (not shown) within gas turbine combustor 14 to facilitate controlling emissions of gas turbine 10, and more specifically to facilitate reducing the combustion temperature and reducing nitrous oxide emissions from gas turbine 10. In the exemplary embodiment, IGCC system 50 includes a compressor 60 for compressing the nitrogen process gas flow before being injected into the combustion zone.

Gasifier 56 converts a mixture of fuel, O₂ supplied by air separation unit 54, steam, and/or fluxant into an output of syngas for use by gas turbine 10 as fuel. Although gasifier 56 may use any fuel, in some IGCC systems 50, gasifier 56 uses coal, petroleum coke, residual oil, oil emulsions, tar sands, and/or other similar fuels. In some IGCC systems 50, the syngas generated by gasifier 56 includes carbon dioxide. In the exemplary embodiment, syngas generated by gasifier 56 is cleaned in a clean-up device 62 before being channeled to gas turbine combustor 14 for combustion thereof. Carbon dioxide (CO₂) may be separated from the syngas during clean-up and, in some IGCC system 50, may be vented to the atmosphere. Gas turbine 10 drives a generator 64 that supplies electrical power to a power grid (not shown). Exhaust gases from gas turbine 10 are channeled to a heat recovery steam generator 66 that generates steam for driving steam turbine 58. Power generated by steam turbine 58 drives an electrical generator 68 that provides electrical power to the power grid. In some IGCC systems 50, steam from heat recovery steam generator 66 is supplied to gasifier 56 for generating syngas.

Furthermore, in the exemplary embodiment, system 50 includes a pump 70 that supplies boiler feed water 72 from power block to a radiant syngas cooler (not shown) connected to the gasifier 56 to facilitate cooling the syngas flowing from the gasifier 56. Boiler feed water 72 is channeled through the radiant syngas cooler wherein boiler feed water 72 is converted to steam 74. Steam 74 is then returned to steam generator 66 for use within gasifier 56 or steam turbine 58.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

It is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

Furthermore, the skilled artisan will recognize the interchangeability of various features from different embodiments. The various features described, as well as other known equivalents for each feature, can be mixed and matched by one of ordinary skill in this art to construct additional systems and techniques in accordance with principles of this disclosure.

1. A gasification reactor, comprising:
a vessel defining a reaction chamber therein, the reaction chamber configured to receive a carbon-containing fuel and an oxygen-containing gas therein under a partial combustion and produce a synthesis gas therein; the vessel comprising:
a first upper region; and
a second middle region;
a first cooling device; attached to the first upper region; and
a second cooling device, attached to the second middle region.

2. The gasification reactor of claim 1, wherein the first upper region is dome-shaped, and the first cooling device comprises a conical pipe attached to the inner side of the dome-shaped first upper region, the conical pipe comprising an inlet for introducing a coolant and an outlet for withdrawing the coolant.

3. The gasification reactor of claim 1, wherein the second cooling device is attached to the inner side of the second middle region, the second cooling device comprises a plurality of pipes extending substantially in parallel along a longitudinal axis of the second middle region.

4. The gasification reactor of claim 3, wherein the plurality of pipes are sequentially connected to form a single pipe, and the single pipe comprises an inlet for introducing a coolant and an outlet for withdrawing the coolant.

5. The gasification reactor of claim 1, wherein the vessel further comprises a third lower region, and the gasification reactor further comprises a third cooling device attached to the third lower region.

6. The gasification reactor of claim 5, wherein the third lower region is cone-shaped, and the third cooling device comprises a conical pipe attached to the inner surface of the cone-shaped third lower region, the conical pipe comprises an inlet for introducing a coolant and an outlet for withdrawing the coolant.

7. The gasification reactor of claim 1, wherein the vessel further comprises a third lower region connected to the second middle region, the third lower region is arranged with a third cooling device attached to an inner side of the third lower region, and wherein the first cooling device, the second cooling device, and the third cooling device are sequentially connected to form a single pipe, and the single pipe comprises an inlet for introducing a coolant and an outlet for withdrawing the coolant.

8. A gasification reactor, comprising:
a vessel defining a reaction chamber for carbon-containing fuel and oxygen-containing gas to partially combust therein, the vessel having an outer side and an inner side; and
a heat exchanger attached to at least a portion of the outer side of the vessel; wherein the heat exchanger is configured for absorbing heat from the reaction chamber.

9. The gasification reactor of claim 8, wherein the heat exchanger is further configured for delivering heat to at least a region of the vessel.

10. The gasification reactor of claim 8, wherein the heat exchanger comprises a plurality of pipes extending in a circular pattern around the outer side of the vessel.

11. The gasification reactor of claim 8, wherein the heat exchanger comprises a single pipe extending around the outer side of the vessel substantially in a spiral pattern.

12. The gasification reactor of claim 8, wherein the heat exchanger comprises:
a first circular pipe;
a second circular pipe; and
a plurality of vertical pipes coupled between the first circular pipe and the second circular pipe.

13. The gasification reactor of claim 8, wherein the heat exchanger comprises:
a first pipe assembly comprising a plurality of circular pipes and a plurality of vertical pipes interconnected with each other; and
a second pipe assembly comprising a plurality of circular pipes and a plurality of vertical pipes interconnected with each other; wherein the first pipe assembly and the second pipe assembly are separated from each other by a predetermined distance.

14. A method, comprising:
cooling a first region of a vessel of a gasification reactor using a first cooling device associated with the first region, wherein the first cooling device defines a shape at least partially matching with the first region; and
cooling a second region of the vessel of the gasification reactor using a second cooling device associated with the second region, wherein the second cooling device defines a shape at least partially matching with the second region.

15. The method of claim 14, wherein the vessel of the gasification reactor further comprises a third region, the method further comprising cooling the third region of the gasification reactor using a third cooling device associated with the third region, wherein the third cooling device defines a shape at least partially matching with the third region.

16. A cooling system, comprising:
a first cooling device attached to a first upper region of a gasification reactor; and
a second cooling device attached to a second middle region of the gasification reactor;
wherein the first cooling device and the second cooling device having a shape matching with the first upper region and the second middle region respectively.

17. A method of regulating a temperature of a wall of a gasification reactor, the method comprising:
obtaining a temperature profile of the gasification reactor, the temperature profile including at least a first temperature zone around a first region of the wall and a second temperature zone around a second region of the wall;
employing a first cooling strategy to cool the first region of the gasification reactor according to the obtained first temperature zone around the first region by using a first cooling device associated with the first region; and
employing a second cooling strategy to cool the second region of the gasification according to the obtained second temperature zone around the second region of the gasification reactor by using a second cooling device associated with the second region.

18. The method of claim 17, further comprising employing a third cooling strategy to cool a third region of the wall according to an obtained third temperature zone around the third region of the wall by using a third cooling device associated with the third region.

19. An integrated gasification combined-cycle power generation system, comprising:
a gasifier comprising:
a vessel defining a reaction chamber therein, the reaction chamber configured to receive a carbon-containing fuel and an oxygen-containing gas therein under a partial combustion and produce a synthesis gas therein; the vessel comprising:
a first region; and
a second region; and
a cooling system comprising:
a first cooling device associated with the first region; and
a second cooling device associated with the second region; and
a gas turbine coupled in flow communication to the gasifier, the gas turbine is configured to combust the synthesis gas received from the gasifier.
